(19) United States
(12) Patent Application Publication
(10) Pub. No.: US 2026/0066467 A1
(43) Pub. Date: Mar. 5, 2026

(54) ALL SOLID BATTERY, PACKAGE COMPONENT AND MANUFACTURING METHOD OF ALL SOLID BATTERY

(71) Applicant: TAIYO YUDEN CO., LTD., Tokyo (JP)

(72) Inventors: Yoko ORIMO, Tokyo (JP); Daigo ITO, Tokyo (JP)

(73) Assignee: TAIYO YUDEN CO., LTD., Tokyo (JP)

(21) Appl. No.: 19/279,798

(22) Filed: Jul. 24, 2025

(30) Foreign Application Priority Data
Aug. 29, 2024 (JP) 2024-147859

(51) Int. Cl. H01M 50/46; H01M 10/058

(52) U.S. Cl. CPC H01M 50/46; H01M 10/058

(57) ABSTRACT

An all solid battery includes a multilayer body having a substantially rectangular parallelepiped shape, in which a first electrode layer including a first electrode and a first margin portion and a second electrode layer including a second electrode different from the first electrode and a second margin portion are stacked in multiple layers with a solid electrolyte layer sandwiched therebetween. Among four side faces other than an upper face and a lower face at ends of the multilayer body in a stacking direction, the first margin portion is arranged so as to be exposed to first two side faces facing each other, the first electrode is extended to second two side faces other than the first two side faces, the second margin portion is arranged so as to be exposed to the second two side faces, and the second electrode is extended to the first two side faces.

### CROSS-REFERENCE TO RELATED APPLICATION

This application is based upon and claims the benefit of priority of the prior Japanese Patent Application No. 2024-147859, filed on Aug. 29, 2024, the entire contents of which are incorporated herein by reference.

### FIELD

A certain aspect of the present invention relates to an all solid battery, a package component and a manufacturing method of the all solid battery.

### BACKGROUND

In recent years, secondary batteries have been used in a variety of fields. Secondary batteries that use liquid electrolyte have problems such as electrolyte leakage. Therefore, development of all solid batteries that have a solid electrolyte and other components that are also solid is being developed.

In the field of such all solid batteries, in order to achieve high energy density, a stacked-type all solid battery has been proposed that includes a multilayer body in which two or more battery units (also called single cells), each of which is made up of a positive electrode, a solid electrolyte layer, and a negative electrode, are stacked and integrated together (for example, see Japanese Patent Application Publication No. 2007-80812, Japanese Patent Application Publication No. 2014-192041, Japanese Patent Application Publication No. 2021-144897, Japanese Patent Application Publication No. 2020-115450, Japanese Patent Application Publication No. 2023-35436, and Japanese Patent Application Publication No. 2021-44186)

### SUMMARY OF THE INVENTION

According to an aspect of the present invention, there is provided an all solid battery including: a multilayer body having a substantially rectangular parallelepiped shape, in which a first electrode layer including a first electrode and a first margin portion and a second electrode layer including a second electrode different from the first electrode and a second margin portion are stacked in multiple layers with a solid electrolyte layer sandwiched therebetween, wherein among four side faces other than an upper face and a lower face at ends of the multilayer body in a stacking direction, the first margin portion is arranged so as to be exposed to first two side faces facing each other, the first electrode is extended to second two side faces other than the first two side faces, the second margin portion is arranged so as to be exposed to the second two side faces, and the second electrode is extended to the first two side faces.

According to an aspect of the present invention, there is provided a package component including: a board; the above-mentioned all solid battery which is mounted on the board; and an exterior member that isolates the all solid battery from outside air.

According to an aspect of the present invention, there is provided a manufacturing method of an all solid battery including: firing a multilayer body having a substantially rectangular parallelepiped shape, in which a first electrode layer including a first electrode pattern and a first margin portion paste and a second electrode layer including a second electrode pattern different from the first electrode pattern and a second margin portion paste are stacked in multiple layers with a solid electrolyte layer green sheet sandwiched therebetween, wherein among four side faces other than an upper face and a lower face at ends of the multilayer body in a stacking direction, the first margin portion paste is arranged so as to be exposed to first two side faces facing each other, the first electrode pattern is extended to second two side faces other than the first two side faces, the second margin portion paste is arranged so as to be exposed to the second two side faces, and the second electrode pattern is extended to the first two side faces.

### BRIEF DESCRIPTION OF THE DRAWINGS

FIG. 1 illustrates a schematic cross section of a basic structure of an all solid battery;

FIG. 2A and FIG. 2B are perspective views of a multilayer chip in which multiple battery units are stacked;

FIG. 3 is a cross-sectional view taken along a line A-A in FIG. 2A;

FIG. 4 is a cross-sectional view taken along a line B-B in FIG. 2A;

FIG. 5A is an enlarged view of a cross-section of a first side margin, and FIG. 5B is an enlarged view of a cross-section of a second side margin;

FIG. 6A is an enlarged view of a cross-section of a first end margin, and FIG. 6B is an enlarged view of a cross-section of a second end margin;

FIG. 7 is a perspective view of a stacked type all solid battery;

FIG. 8 is a diagram of how an all solid battery is mounted on a mounting board;

FIG. 9 is a cross-sectional view of an all solid battery mounted on a mounting board;

FIG. 10 is a transparent view of a package component in which an all solid battery is sealed;

FIG. 11A and FIG. 11B are diagrams of package components;

FIG. 12 is a diagram of a multilayer structure;

FIG. 13 is a diagram of a flow of a manufacturing method for an all solid battery;

FIG. 14 is a diagram of a stacking process;

FIG. 15 is a diagram of a cutting process;

FIG. 16 illustrates Comparative Example;

FIG. 17 illustrates Comparative Example; and

FIG. 18 illustrates Comparative Example.

### DETAILED DESCRIPTION

Japanese Patent Application Publication No. 2007-80812 discloses an internal electrode structure of an all solid battery that has a multilayer structure similar to that of a multilayer ceramic capacitor. When the positive electrode and the negative electrode are stacked with a solid electrolyte layer sandwiched therebetween, a gap occurs in the total thickness between the electrode intersection and non-intersection parts of the positive and negative electrode, resulting in distortion. Since such distortion may cause cracks and short circuits, it is effective to provide a margin around the electrode as in Japanese Patent Application Publication No. 2014-192041. According to Japanese Patent Application Publication No. 2014-192041, the shape of the margin in a top view has a lateral C shaped that surrounds three sides of the rectangular electrode.

If a mismatch occurs in the shrinkage behavior of the electrode and the margin during heat treatment, problems such as cracks will occur during the sintering process. It has been made clear from various simulations that the margin part formed in a lateral C shape on the outer periphery of the electrode as in Japanese Patent Application Publication No. 2014-192041 will cause internal stress during sintering if there is even a slight mismatch in thermal shrinkage with the electrode. In Japanese Patent Application Publication No. 2021-144897, the margin is also formed in a lateral C shape, and therefore there are many bent portions at the boundary with the electrode, which makes it easy for cracks to occur due to thermal contraction mismatch during sintering.

A description will be given of an embodiment with reference to the accompanying drawings.

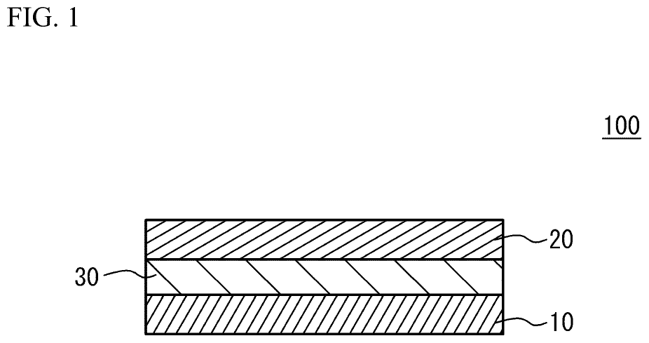

(Embodiment) FIG. 1 illustrates a schematic cross section of a basic structure of an all solid battery 100 in accordance with an embodiment. As illustrated in FIG. 1, the all solid battery 100 has a structure in which a positive electrode 10 and a negative electrode 20 sandwich a solid electrolyte layer 30. The positive electrode 10 is provided on a first main face of the solid electrolyte layer 30. The negative electrode 20 is provided on a second main face of the solid electrolyte layer 30. For example, the positive electrode 10, the negative electrode 20 and the solid electrolyte layer 30 have a sintered body which is formed by sintering powder materials.

A main component of the solid electrolyte layer 30 is a solid electrolyte having ionic conductivity. The solid electrolyte of the solid electrolyte layer 30 is an oxide-based solid electrolyte having lithium ion conductivity. The solid electrolyte is, for example, phosphoric acid salt-based electrolyte having a NASICON crystal structure. The phosphoric acid salt-based electrolyte having a NASICON-type crystal structure has the properties of having high electrical conductivity and being stable in the air. For example, the solid electrolyte of the solid electrolyte layer 30 is oxide-based solid electrolyte having lithium ion conductivity. The phosphoric acid salt is not limited. For example, the phosphoric acid salt is such as composite salt of phosphoric acid with Ti (for example LiTi₂(PO₄)₃). Alternatively, at least a part of Ti may be replaced with a transition metal of which a valence is four, such as Ge, Sn, Hf, or Zr. In order to increase an amount of Li, a part of Ti may be replaced with a transition metal of which a valence is three, such as Al, Ga, In, Y or La. In concrete, the phosphoric acid salt is Li₁₊ₓAlₓGe₂₋ₓ(PO₄)₃, Li₁₊ₓAlₓZr₂₋ₓ(PO₄)₃, Li₁₊ₓAlₓT₂₋ₓ(PO₄)₃ or the like. For example, a Li—Al—Ge—PG₄ (LAGP) material to which the same transition metal as that contained in the phosphoric acid salt having an olivine crystal structure contained in the positive electrode 10 and the negative electrode 20 is added in advance is preferable. For example, when the positive electrode 10 and the negative electrode 20 contain a phosphoric acid salt containing Co and Li, it is preferable that the Li—Al—Ge—PO₄-based material to which Co has been added in advance is contained in the solid electrolyte layer 30. In this case, an effect of suppressing the elution of the transition metal contained in the electrode active material into the electrolyte is obtained. When the positive electrode 10 and the negative electrode 20 contain a phosphoric acid salt containing a transition element other than Co and Li, it is preferable that the Li—Al—Ge—PO₄-based material to which the transition metal has been added in advance is contained in the solid electrolyte layer 30.

The positive electrode 10 contains a material having an olivine crystal structure as an electrode active material. It is preferable that the negative electrode 20 also contains the electrode active material. An example of such an electrode active material is a phosphate containing a transition metal and lithium. The olivine crystal structure is a crystal that natural olivine has, and can be identified by X-ray diffraction.

A typical example of an electrode active material having an olivine crystal structure is LiCoPO₄ containing Co. Phosphates in which the transition metal Co is replaced in this chemical formula may also be used. Here, the ratio of Li and PO₄ can vary depending on the valence. Note that it is preferable to use Co, Mn, Fe, Ni or the like as the transition metal.

The electrode active material having an olivine crystal structure acts as a positive electrode active material in the positive electrode 10. For example, when only the positive electrode 10 contains an electrode active material having an olivine crystal structure, the electrode active material acts as a positive electrode active material. When the negative electrode 20 also contains an electrode active material having an olivine crystal structure, the negative electrode 20 exhibits the effects of increasing the discharge capacity and increasing the operating potential with discharge, which is presumed to be based on the formation of a partial solid solution state with the negative electrode active material, although the mechanism of action is not completely clear.

When both the positive electrode 10 and the negative electrode 20 contain electrode active materials having an olivine crystal structure, each electrode active material preferably contains a transition metal that may be the same as or different from each other. “May be the same as or different from each other” means that the electrode active materials contained in the positive electrode 10 and the negative electrode 20 may contain the same type of transition metal, or may contain different types of transition metal. The positive electrode 10 and the negative electrode 20 may contain only one type of transition metal, or may contain two or more types of transition metals. Preferably, the positive electrode 10 and the negative electrode 20 contain the same type of transition metal. More preferably, the electrode active material contained in both electrodes has the same chemical composition. By containing the same type of transition metal or the same composition of electrode active material in the positive electrode 10 and the negative electrode 20, the similarity of the composition of both internal electrode layers is increased, so that even if the terminals of the all solid battery 100 are attached in the opposite direction, it has the effect of being able to withstand practical use without malfunction depending on the application.

The negative electrode 20 contains a negative electrode active material. By containing a negative electrode active material in only one electrode, it becomes clear that the one electrode acts as a negative electrode and the other electrode acts as a positive electrode. Note that both electrodes may contain a material known as a negative electrode active material. For the negative electrode active material of the electrode, reference can be made to conventional techniques in secondary batteries as appropriate, and examples thereof include compounds such as titanium oxide, lithium titanium composite oxide, lithium titanium composite phosphate, carbon, lithium vanadium phosphate or the like.

In the production of the positive electrode 10 and the negative electrode 20, in addition to these electrode active materials, a solid electrolyte having ion conductivity and a conductive material (conductive assistant) are added. For these components, an internal electrode paste can be obtained by uniformly dispersing a binder and a plasticizer in water or an organic solvent.

The conductive assistant may contain a carbon material or the like. The conductive assistant may contain a metal. Examples of the metal of the conductive assistant include Pd, Ni, Cu, Fe, or alloys containing these. The solid electrolyte contained in the positive electrode 10 and the negative electrode 20 can be the same as the main solid electrolyte of the solid electrolyte layer 30, for example.

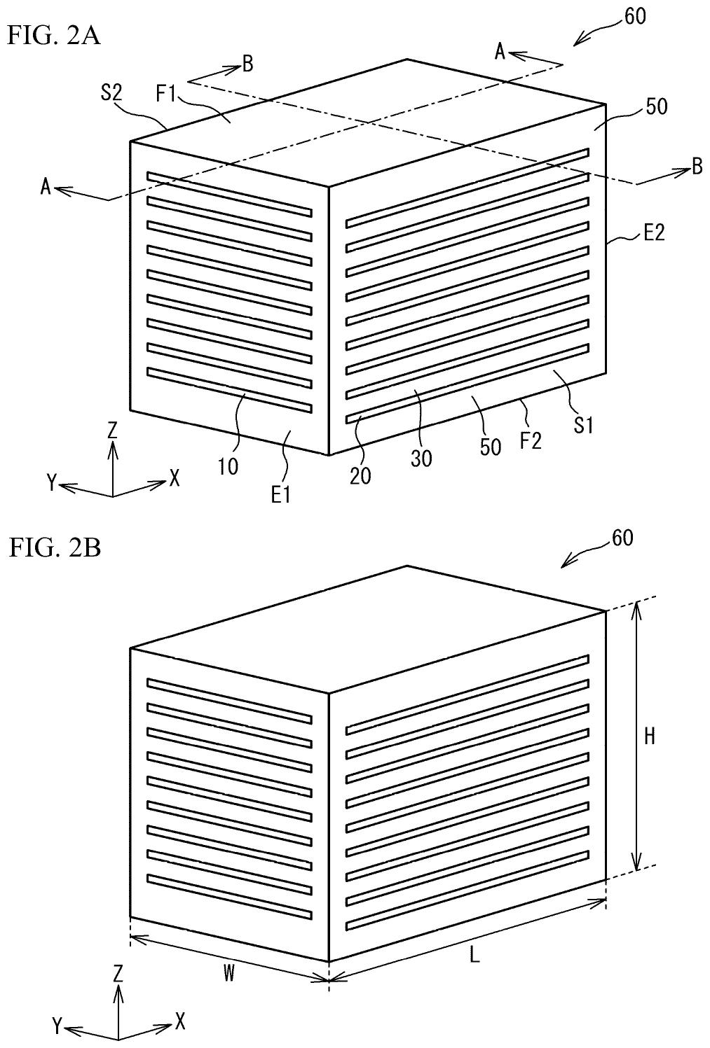

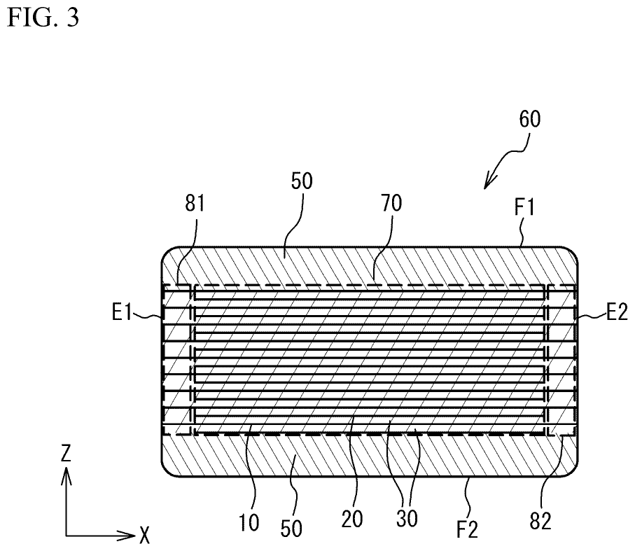

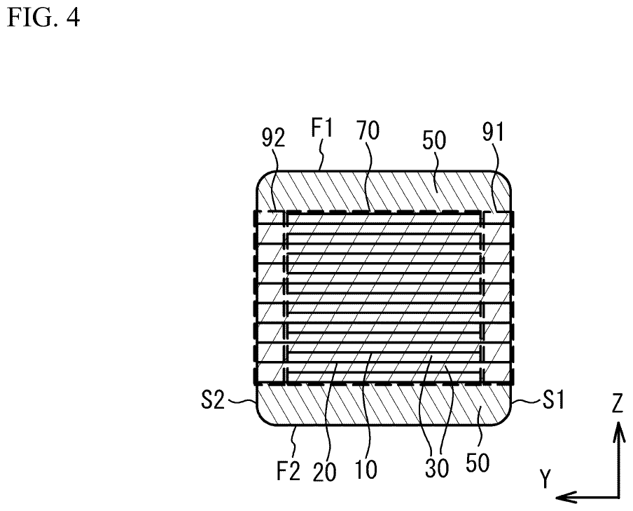

FIG. 2A and FIG. 2B are perspective views of a multilayer chip 60 in which multiple battery units are stacked. FIG. 3 is a cross-sectional view taken along a line A-A in FIG. 2A. FIG. 4 is a cross-sectional view taken along a line B-B in FIG. 2A. The multilayer chip 60 has a generally rectangular parallelepiped shape. The multilayer chip 60 has an upper face F1 and a lower face F2 at the ends of the stacking direction of each layer, and four side surfaces. The four side surfaces include a first side face S1 and a second side face S2 (first two side faces) that face each other, and a first end face E1 and a second end face E2 (second two side faces) that face each other.

In FIG. 2A, FIG. 2B, FIG. 3, and FIG. 4, the Z-axis direction (first direction) is the stacking direction, and is the direction in which the upper face F1 and the lower face F2 of the multilayer chip 60 face each other. The X-axis direction (second direction) is the direction in which the first end face E1 and the second end face E2 of the multilayer chip 60 face each other. The Y-axis direction (third direction) is the direction in which the first side face S1 and the second side face S2 face each other. The X-axis direction, the Y-axis direction, and the Z-axis direction are mutually orthogonal.

As illustrated in FIG. 2B, the length (first length) of the multilayer chip 60 in the X-axis direction is represented as length L. The width (second length) of the multilayer chip 60 in the Y-axis direction is represented as width W. The height of the multilayer chip 60 in the Z-axis direction is represented as height H.

In the following description, those having the same composition range as the all solid battery 100 are given the same reference numerals and detailed description is omitted.

In the multilayer chip 60, the positive electrodes 10 and the negative electrodes 20 are alternately stacked with the solid electrolyte layer 30 interposed therebetween. Both ends of the positive electrodes 10 in the X-axis direction are drawn to the first end face E1 and the second end face E2 of the multilayer chip 60, but are not drawn to the first side face S1 and the second side face S2. Both ends of the negative electrodes 20 in the Y-axis direction are drawn to the first side face S1 and the second side face S2 of the multilayer chip 60, but are not drawn to the first end face E1 and the second end face E2. The solid electrolyte layer 30 extends from the first end face E1 to the second end face E2, and further extends from the first side face S1 to the second side face S2. In this way, the multilayer chip 60 has a structure in which multiple battery units are stacked.

A cover layer 50 is stacked on the upper end faces of the multilayer portion of the positive electrode 10, the solid electrolyte layer 30, and the negative electrode 20. The cover layer 50 is in contact with the uppermost electrode (either the positive electrode 10 or the negative electrode 20) and is in contact with a part of the solid electrolyte layer 30. Another cover layer 50 is also stacked on the lower end face of the multilayer portion. The cover layer 50 is in contact with the lowermost electrode (either the positive electrode 10 or the negative electrode 20) and is in contact with a part of the solid electrolyte layer 30. For example, the cover layer 50 is a sintered body obtained by sintering a powder material.

As illustrated in FIG. 3, the section where the positive electrode 10 and the negative electrode 20 face each other is a region that generates battery capacity. Therefore, this section is called a battery capacity section 70. In other words, the battery capacity section 70 is a section where the electrode drawn out to the two end faces face each other with the electrode drawn out to the two side faces.

The section where the positive electrodes 10 face each other without the negative electrode 20 in between near the first end face E1 is called a first end margin 81. Also, the section where the positive electrodes 10 face each other without the negative electrode 20 in between near the second end face E2 is called a second end margin 82. In other words, the end margin is a section where the electrodes drawn out to the two end faces face each other without the electrodes drawn out to the two side faces in between. The first end margin 81 and the second end margin 82 are sections that do not generate battery capacity.

As illustrated in FIG. 4, in the multilayer chip 60, the section near the first side face S1 where the negative electrodes 20 face each other without the positive electrode 10 interposed therebetween is referred to as a first side margin 91. Additionally, the section near the second side face S2 where the negative electrodes 20 face each other without the positive electrode 10 interposed therebetween is referred to as a second side margin 92. In other words, the side margin is the section where the electrodes extended to the two side faces face each other without the electrodes extended to the two end faces interposed therebetween. The first side margin 91 and the second side margin 92 are sections that do not produce battery capacity.

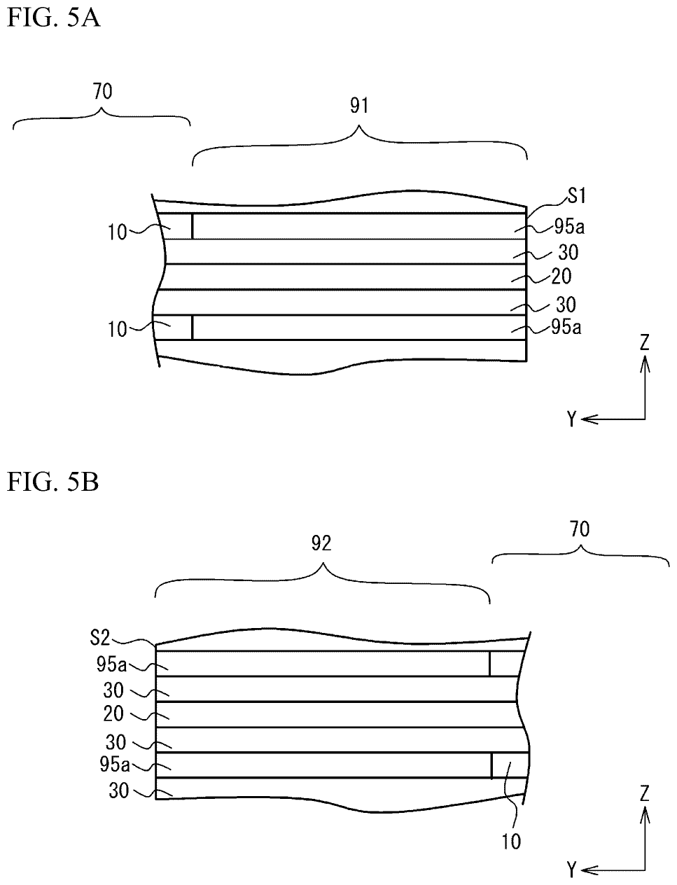

FIG. 5A is an enlarged view of a cross section of the first side margin 91. In the first side margin 91, the negative electrode 20 extends to the first side face S1, and the positive electrode 10 does not extend to the first side face S1. In the same layer as the positive electrode 10, a positive electrode margin portion 95a is provided and exposed to the first side face S1. With this configuration, the step between the battery capacity section 70 and the first side margin 91 is suppressed.

FIG. 5B is an enlarged view of a cross section of the second side margin 92. In the second side margin 92, the negative electrode 20 extends to the second side face S2, and the positive electrode 10 does not extend to the second side face S2. In the same layer as the positive electrode 10, the positive electrode margin portion 95a is provided and exposed to the second side face S2. According to this configuration, the step between the battery capacity section 70 and the second side margin 92 is suppressed.

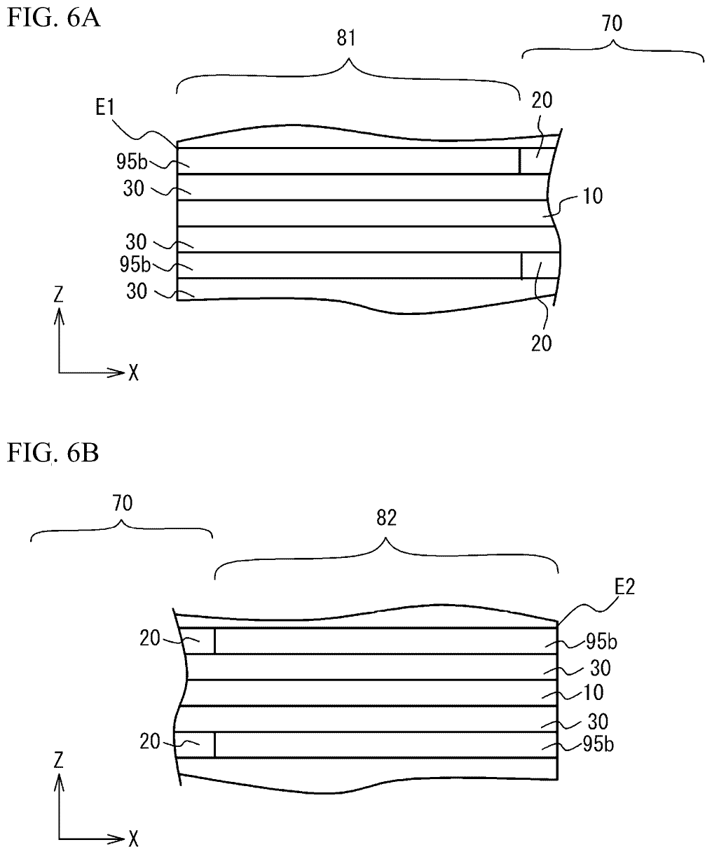

FIG. 6A is an enlarged view of a cross section of the first end margin 81. In the first end margin 81, the positive electrode 10 extends to the first end face E1, and the negative electrode 20 does not extend to the first end face E1. In the same layer as the negative electrode 20, a negative electrode margin portion 95b is provided and is exposed to the first end face E1. According to this configuration, the step between the battery capacity section 70 and the first end margin 81 is suppressed.

FIG. 6B is an enlarged view of a cross section of the second end margin 82. In the second end margin 82, the positive electrode 10 extends to the second end face E2, and the negative electrode 20 does not extend to the second end face E2. The negative electrode margin portion 95b is provided in the same layer as the negative electrode 20 and is exposed to the second end face E2. With this configuration, the step between the battery capacity section 70 and the second end margin 82 is suppressed.

In this embodiment, one of the positive electrode 10 and the negative electrode 20 corresponds to the first electrode, and the other corresponds to the second electrode. When the positive electrode 10 corresponds to the first electrode, the positive electrode margin portion 95a corresponds to the first margin portion, and the negative electrode margin portion 95b corresponds to the second margin portion. When the negative electrode 20 corresponds to the first electrode, the negative electrode margin portion 95b corresponds to the first margin portion, and the positive electrode margin portion 95a corresponds to the second margin portion.

The positive electrode margin portion 95a and the negative electrode margin portion 95b are not particularly limited as long as they have insulating properties. For example, the positive electrode margin portion 95a and the negative electrode margin portion 95b may have the same composition as the solid electrolyte layer 30. Or, the positive electrode margin portion 95a and the negative electrode margin portion 95b may have a composition different from that of the solid electrolyte layer 30. For example, the main component of the positive electrode margin portion 95a and the negative electrode margin portion 95b may be the same as the main component of the solid electrolyte layer 30, and the additive element in the positive electrode margin portion 95a and the negative electrode margin portion 95b may be different from the additive element in the solid electrolyte layer 30. Alternatively, the main component of the positive electrode margin portion 95a and the negative electrode margin portion 95b may be the same as the main component of the solid electrolyte layer 30, the additive element in the positive electrode margin portion 95a and the negative electrode margin portion 95b may be the same as the additive element in the solid electrolyte layer 30, and the concentration of the additive element in the positive electrode margin portion 95a and the negative electrode margin portion 95b may be different from the concentration of the additive element in the solid electrolyte layer 30. Alternatively, the main component of the positive electrode margin portion 95a and the negative electrode margin portion 95b may be different from the main component of the solid electrolyte layer 30. The ionic conductivity of the positive electrode margin portion 95a and the negative electrode margin portion 95b may be lower than that of the solid electrolyte layer 30. For example, if the positive electrode margin portion 95a and the negative electrode margin portion 95b have a different composition from that of the solid electrolyte layer 30, when the XZ cross section or the YZ cross section is observed with a scanning electron microscope (SEM), an interface is observed between the negative electrode margin portion 95b and the positive electrode margin portion 95a, and the solid electrolyte layer 30.

The positive electrode margin portion 95a does not contain an electrode active material or has a lower electrode active material concentration than the positive electrode 10. The negative electrode margin portion 95b does not contain an electrode active material or has a lower electrode active material concentration than the negative electrode 20. In these cases, when observed with an SEM, an interface is observed between the positive electrode margin portion 95a and the positive electrode 10, and an interface is observed between the negative electrode margin portion 95b and the negative electrode 20.

For example, the material of the negative electrode margin portion 95b and the positive electrode margin portion 95a may be glass, alumina, or the like.

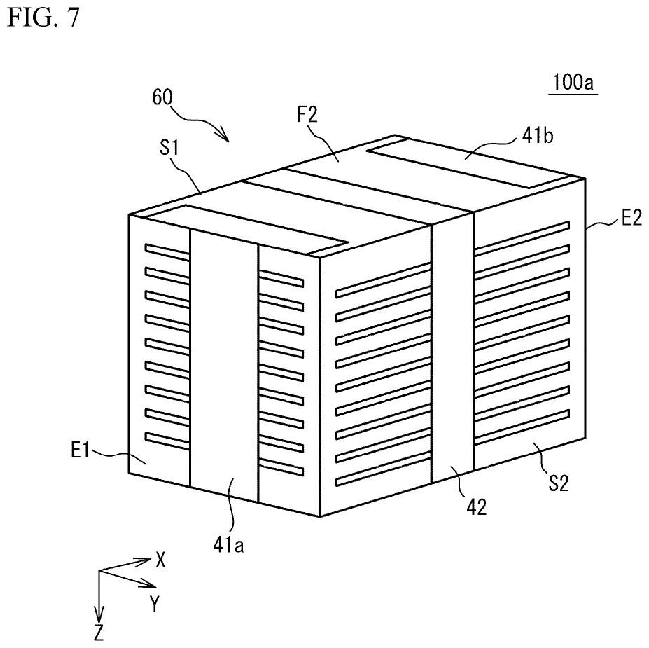

FIG. 7 is a perspective view of a stacked type all solid battery 100a. As illustrated in FIG. 7, the all solid battery 100a has a configuration in which the multilayer chip 60 is provided with first external electrodes 41a and 41b and a second external electrode 42. Note that FIG. 7 illustrates the all solid battery 100a upside down, so the upper face is the lower face F2, and the lower face is the upper face F1.

The first external electrode 41a is provided so as to contact the first end face E1, and the first external electrode 41b is provided so as to contact the second end face E2. Therefore, the first external electrode 41a and the first external electrode 41b are connected to each of the positive electrodes 10 and function as a positive electrode terminal. The second external electrode 42 extends so as to contact the second side face S2 via the lower face F2 from the first side face S1. Therefore, the second external electrode 42 is connected to each of the negative electrodes 20 and functions as a negative electrode terminal.

The first external electrode 41a may cover the entire first end face E1, or may cover a part of the first end face E1. The first external electrode 41b may cover the entire second end face E2, or may cover a part of the second end face E2. The second external electrode 42 may cover the entire first side face S1, the lower face F2, and the second side face S2, or may cover a part of at least one of the three faces. However, in order to prevent short circuits, the second external electrode 42 is separated from the first external electrode 41a and the first external electrode 41b.

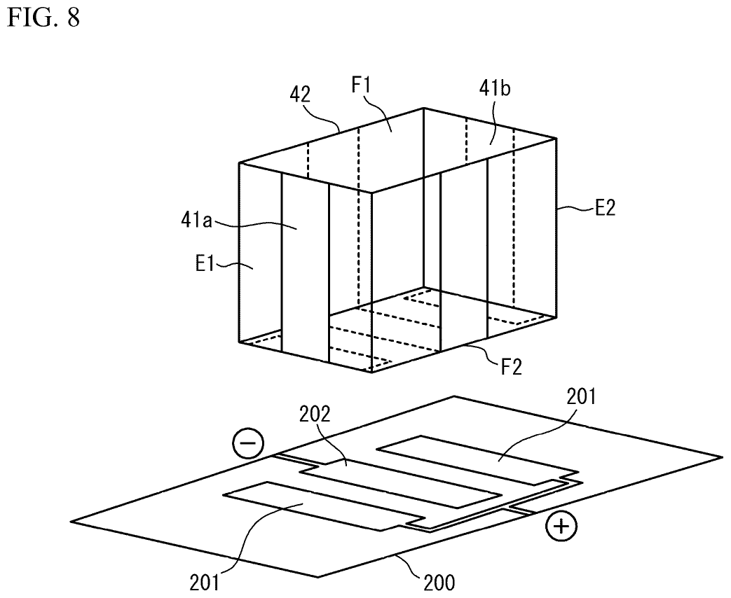

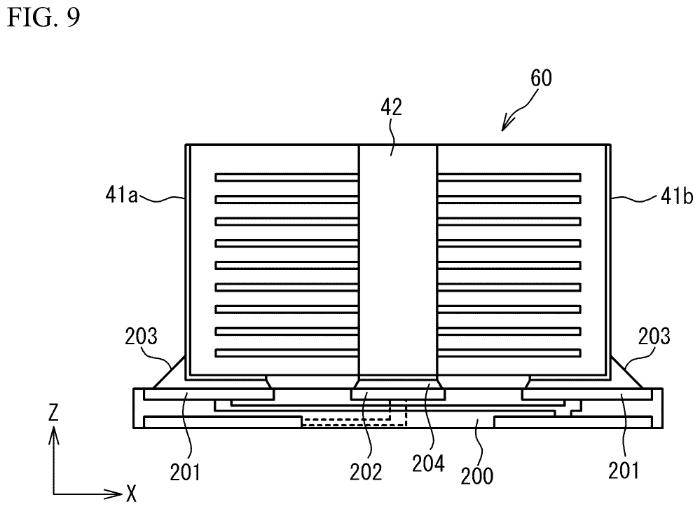

FIG. 8 is a diagram of how the all solid battery 100a is mounted on a mounting board 200. As illustrated in FIG. 8, the mounting board 200 includes two positive electrode lands 201 for the positive electrode and a negative electrode land 202 for the negative electrode. The first external electrodes 41a and 41b on the lower face F2 are connected to the positive electrode land 201 via a solder 203. The second external electrode 42 on the lower face F2 is connected to the negative electrode land 202 via a solder 204. FIG. 9 illustrates a cross-sectional view illustrating the all solid battery 100a mounted on the mounting board 200. In this way, by providing three or more joints when soldering the external electrodes and the mounting substrate, the strength of the adhesion to the mounting substrate can be improved.

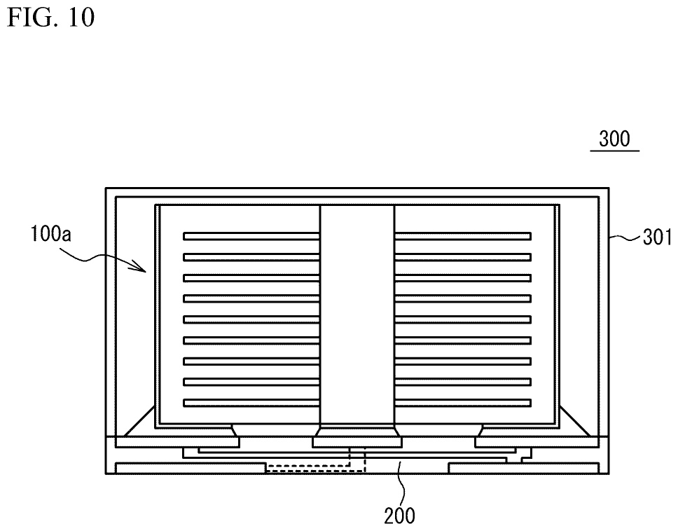

FIG. 10 is a transparent view illustrating a package component 300 in which the all solid battery 100a is sealed. As illustrated in FIG. 10, an exterior member 301 is provided on the mounting board 200. The exterior member 301 is provided so as to cover the entire of the all solid battery 100a exposed on the mounting board 200. As a result, the all solid battery 100a is isolated from the outside air, and the first end face E1, the second end face E2, the first side face S1, and the second side face S2 of the multilayer chip 60 are sealed and are not exposed to the outside air. The exterior member 301 is made of an insulating material. The exterior member 301 may be a ceramic case or the like, or may be a molded resin. Furthermore, when there is a gap between the exterior member 301 and the all solid battery 100a, the gap may be an air gap, or a sealant such as a resin may be provided in the gap.

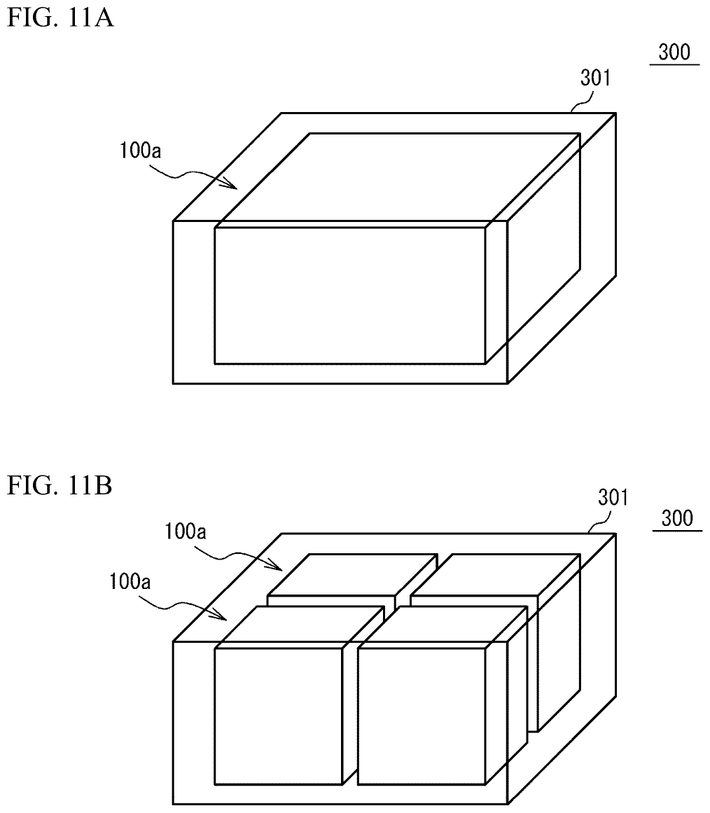

As illustrated in FIG. 11A, the exterior member 301 may seal one of the all solid batteries 100a. Or, as illustrated in FIG. 11B, the exterior member 301 may seal multiple all solid batteries 100a.

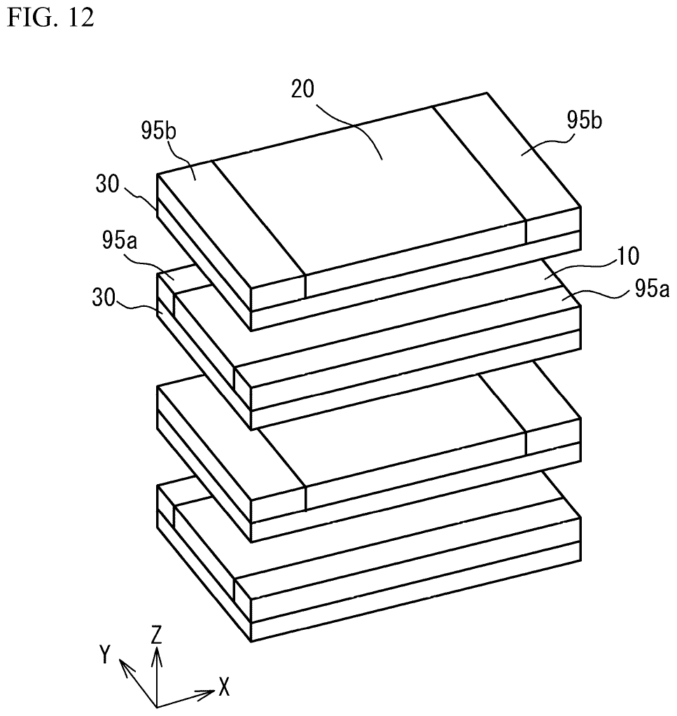

Here, the all solid battery 100a according to this embodiment will be summarized. As illustrated in FIG. 12, the above-mentioned multilayer chip 60 has a rectangular shape in a plan view along the Z-axis direction and has four sides. The positive electrode margin portion 95a provided in the same layer as the positive electrode 10 in the stacking direction is arranged along first two opposing sides of the four sides in a plan view along the Z-axis direction, and the positive electrode 10 is drawn out from second two sides different from the first two sides. The negative electrode margin portion 95b provided in the same layer as the negative electrode 20 in the stacking direction is arranged along second two sides in a plan view along the Z-axis direction, and the negative electrode 20 is drawn out from the first two sides. As a result, the positive electrode margin portion 95a is arranged so as to be exposed to the first side face S1 and the second side face S2 (first two side faces) which face each other as illustrated in FIG. 2A, the positive electrode 10 is drawn out to the first end face E1 and the second end face E2 (second two side faces), the negative electrode margin portion 95b is arranged so as to be exposed to the first end face E1 and the second end face E2, and the negative electrode 20 is drawn out to the first side face S1 and the second side face S2.

In addition, in a plan view along the Z-axis direction, the positive electrode 10 and the two positive electrode margin portions 95a form a quadrangle. Since the positive electrode 10 and the two positive electrode margin portion 95a are arranged in the same layer, the layer formed by the positive electrode 10 and the positive electrode margin portions 95a is also referred to as a positive electrode layer. In addition, in a plan view along the Z-axis direction, the negative electrode 20 and the two negative electrode margin portions 95b form a quadrangle. Since the negative electrode 20 and the two negative electrode margin portions 95b are arranged in the same layer, the layer formed by the negative electrode 20 and the negative electrode margin portions 95b is also referred to as a negative electrode layer.

In a plan view along the Z-axis direction, the four sides of a quadrangle formed by the positive electrode layer overlap with the four sides of a quadrangle formed by the negative electrode layer. In addition, in a plan view, the four sides of a quadrangle formed by the solid electrolyte layer 30 overlap with the four sides of a quadrangle formed by the positive electrode layer and the four sides of a quadrangle formed by the negative electrode layer.

The first external electrodes 41a and 41b (first terminals) are in contact with the positive electrode 10, the solid electrolyte layer 30, and the negative electrode margin portion 95b at the first end face E1 and the second end face E2. The second external electrode 42 (second terminal) is in contact with the negative electrode 20, the solid electrolyte layer 30, and the positive electrode margin portion 95a at the first side face S1 and the second side face S2.

With the above configuration, compared to when the margin portion is formed in a lateral C shape, the interface where the margin portion and the positive electrode contact and the interface where the margin portion and the negative electrode contact can be made smaller. This makes it possible to suppress the effects of thermal contraction mismatch during sintering. As a result, defects such as cracks and warping can be eliminated.

In this embodiment, the positive electrode 10 extends from the first end face E1 to the second end face E2, and the negative electrode 20 extends from the first side face S1 to the second side face S2. Alternatively, the positive electrode 10 may extend from the first side face S1 to the second side face S2, and the negative electrode 20 may extend from the first end face E1 to the second end face E2. In this case, the positive electrode margin portion 95a is exposed to the first end face E1 and the second end face E2, and the negative electrode margin portion 95b is exposed to the first side face S1 and the second side face S2.

If the all solid battery 100a has a cubic shape, it may be difficult to identify the polarity of each external electrode. Therefore, it is preferable that the all solid battery 100a has a substantially rectangular parallelepiped shape. For example, it is preferable that the length L and width W of the multilayer chip 60 are different. In this case, it is possible to identify the polarity of each external electrode. For example, it is preferable that the length L and width W of one of the electrodes are 1.1 times or more larger than the other. Alternatively, by making the shapes of the external electrodes different, it is possible to identify the polarity of each external electrode. For example, if one external electrode is connected at the lower face F2 like the all solid battery 100a and the other external electrode is not connected at the lower face F2, it is possible to identify the polarity of each external electrode. If the polarity of each external electrode can be identified, there is no need to attach a new marker.

The thickness of the solid electrolyte layer 30 is, for example, 1 μm or more and 30 μm or less, 2 μm or more and 20 μm or less, or 3 μm or more and 15 μm or less.

The thicker the positive electrode 10 and the negative electrode 20 are formed, the higher the battery capacity. For example, the thickness of the positive electrode 10 and the negative electrode 20 is preferably 1 μm or more, more preferably 5 μm or more, and even more preferably 10 μm or more. In addition, the thickness of the positive electrode 10 and the negative electrode 20 is preferably 0.03 times or more, more preferably 0.1 times or more, and even more preferably 0.3 times or more, the thickness of the solid electrolyte layer 30. Alternatively, the positive electrode 10 and the negative electrode 20 are preferably thicker than the solid electrolyte layer 30. Note that the thicker the positive electrode 10 and the negative electrode 20 are formed, the larger the interface area between the margin portion and the electrode when the margin portion is formed in a lateral C shape, so that it can be said that the effect of this embodiment is more pronounced.

On the other hand, if the positive electrode 10 and the negative electrode 20 are too thick, there is a risk that cracks will occur during heat treatment after the formation of the multilayer body, and even if no cracks occur, there is a risk that the responsiveness during battery operation will be insufficient. Therefore, it is preferable to set an upper limit on the thickness of the positive electrode 10 and the negative electrode 20. For example, the thickness of the positive electrode 10 and the negative electrode 20 is preferably 200 μm or less, more preferably 100 μm or less, and even more preferably 80 μm or less. Also, the thickness of the positive electrode 10 and the negative electrode 20 is preferably 200 times or less, more preferably 100 times or less, and even more preferably 80 times or less than the thickness of the solid electrolyte layer 30.

The thickness of each layer of the solid electrolyte layer 30 in the Z-axis direction can be measured by observing a cross section of the all solid battery 100a including the Z-axis direction with a SEM (scanning electron microscope), measuring the thickness at 10 points for each of the 10 different layers of the solid electrolyte layer 30, and deriving the average value of all the measurement points. The thickness of each layer of the positive electrode 10 in the Z-axis direction can be measured by observing a cross section of the all solid battery 100a including the Z-axis direction with a SEM, measuring the thickness at 10 points for each of the 10 different layers of the positive electrode 10, and deriving the average value of all the measurement points. The thickness of each layer of the negative electrode 20 in the Z-axis direction can be measured by observing a cross section of the all solid battery 100a including the Z-axis direction with a SEM, measuring the thickness at 10 points for each of the 10 different layers of the negative electrode 20, and deriving the average value of all the measurement points. Furthermore, if the composition of the positive electrode 10 and the composition of the negative electrode 20 are different, cracks are likely to occur due to the difference in thermal contraction behavior between the positive electrode 10 and the negative electrode 20, and therefore the effect of this embodiment can be said to be significantly exhibited.

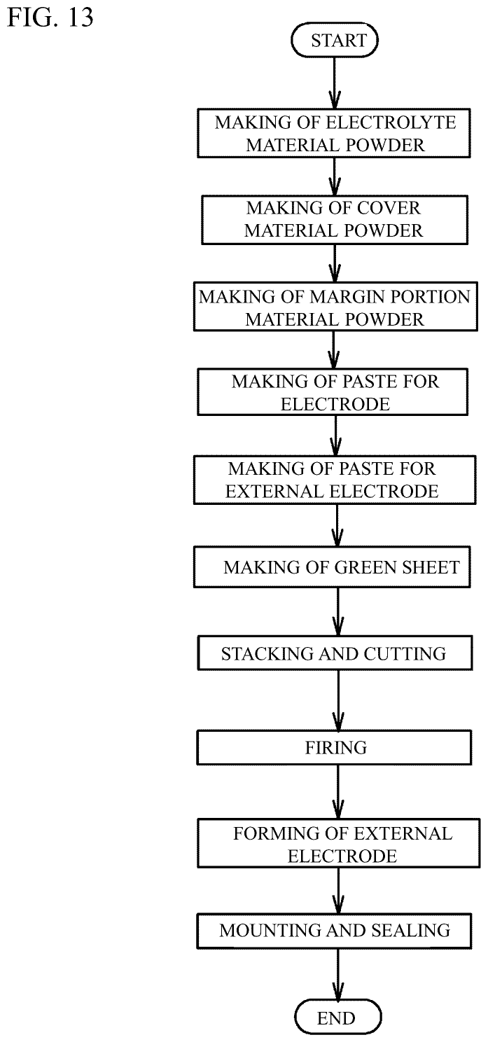

A description will be given of a manufacturing method of the all solid battery 100a. FIG. 13 illustrates a flowchart of the manufacturing method of the all solid battery 100a.

(Making process of raw material powder for solid electrolyte layer) A raw material powder for the solid electrolyte for the solid electrolyte layer 30 is made. For example, it is possible to make the raw material powder for the oxide-based solid electrolyte, by mixing raw material and additives and using solid phase synthesis method or the like. The resulting powder is subjected to dry grinding. Thus, a particle diameter of the resulting power is adjusted to a desired one. For example, it is possible to adjust the particle diameter to the desired diameter with use of planetary ball mill using ZrO₂ ball of 5 mm φ.

(Making process of raw material powder for cover layer) A raw material powder of ceramics for the cover layer 50 is made. For example, it is possible to make the raw material powder for the cover layer, by mixing raw material and additives and using solid phase synthesis method or the like. By dry-pulverizing the obtained raw material powder, it is possible to adjust the obtained material powder to a desired average particle size. For example, the particles are adjusted to a desired average particle size using a planetary ball mill using ZrO₂ balls of 5 mm diameter.

(Making process of raw material powder for margin portion) A raw material powder of ceramics for the negative electrode margin portion 95b and the positive electrode margin portion 95a are made. For example, it is possible to make the raw material powder for the margin portion, by mixing raw material and additives and using solid phase synthesis method or the like. By dry-pulverizing the obtained raw material powder, it is possible to adjust the obtained material powder to a desired average particle size. For example, the particles are adjusted to a desired average particle size using a planetary ball mill using ZrO₂ balls of 5 mm diameter.

(Making process for internal electrode paste) Next, internal electrode pastes for making the positive electrode 10 and the negative electrode 20 described above are separately made. For example, the internal electrode paste can be obtained by uniformly dispersing a conductive auxiliary agent, an electrode active material, a solid electrolyte material, a sintering assistant, a binder, a plasticizer, and the like in water or an organic solvent. The above-mentioned solid electrolyte paste may be used as the solid electrolyte material. A carbon material or the like may be used as the conductive assistant. A metal may be used as the conductive assistant. An example of the metal of the conductive assistant is such as Pd, Ni, Cu, Fe, or alloys containing these. Pd, Ni, Cu, Fe, alloys containing these, and various carbon materials may also be used.

The sintering assistant for the positive electrode paste and the negative electrode paste includes one or more of glass components such as Li—B—O-based compound, Li—Si—O-based compound, Li—C—O-based compound, Li—S—O-based compound and Li—P—O-based compound.

(Making process of external electrode paste) Next, an external electrode paste for manufacturing the first external electrodes 41a and 41b and the second external electrode 42 described above is made. For example, a paste for external electrodes can be obtained by uniformly dispersing a conductive material, glass frit, binder, plasticizer and so on in water or an organic solvent.

(Making process of green sheet) By uniformly dispersing the raw material powder for the solid electrolyte layer in an aqueous or organic solvent together with a binder, dispersant, plasticizer and so on and performing wet pulverization, a solid electrolyte slurry having a desired average particle size can be made. At this time, a bead mill, a wet jet mill, various kneaders, a high-pressure homogenizer, or the like can be used, and it is preferable to use a bead mill from the viewpoint of being able to adjust the particle size distribution and perform dispersion at the same time. A binder is added to the obtained solid electrolyte slurry to obtain a solid electrolyte paste. A solid electrolyte green sheet can be formed by applying the obtained solid electrolyte paste. The coating method is not particularly limited, and a slot die method, reverse coating method, gravure coating method, bar coating method, doctor blade method, or the like can be used. The particle size distribution after wet pulverization can be measured using, for example, a laser diffraction measuring device using a laser diffraction scattering method.

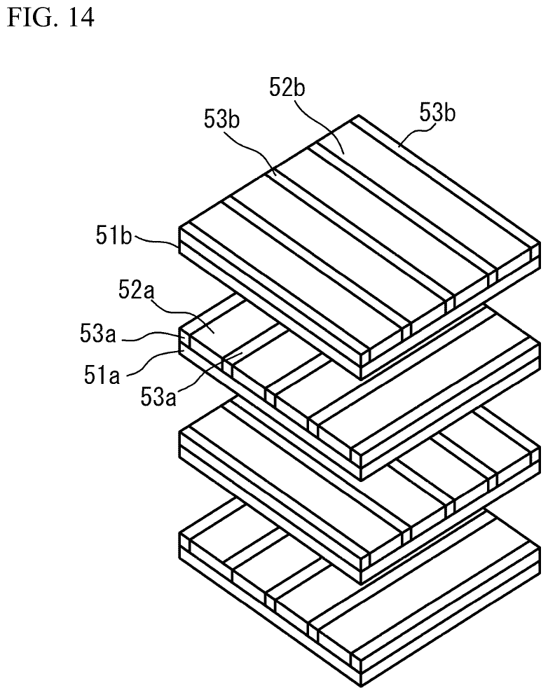

(Stacking and cutting process) As illustrated in FIG. 14, a paste for the positive electrode is printed on one side of a solid electrolyte green sheet 51a, and positive electrode patterns 52a are formed in a strip shape. A positive electrode margin portion paste 53a is printed in the gaps between the positive electrode patterns 52a on the first solid electrolyte green sheet 51a. The positive electrode margin portion paste 53a can be formed by applying raw material powder for the margin portion in the same manner as in the solid electrolyte green sheet preparation process. A paste for the negative electrode portion is printed on one side of a second solid electrolyte green sheet 51b, and negative electrode patterns 52b are formed in a strip shape. A negative electrode margin portion paste 53b is printed in the gaps between the negative electrode patterns 52b on the second solid electrolyte green sheet 51b.

As illustrated in FIG. 14, the multiple first solid electrolyte green sheets 51a and the multiple second solid electrolyte green sheets 51b are alternately stacked after printing so that the direction in which the positive electrode pattern 52a extends is orthogonal to the direction in which the negative electrode pattern 52b extends. A multilayer body is obtained by pressing cover sheets from above and below the stacking direction.

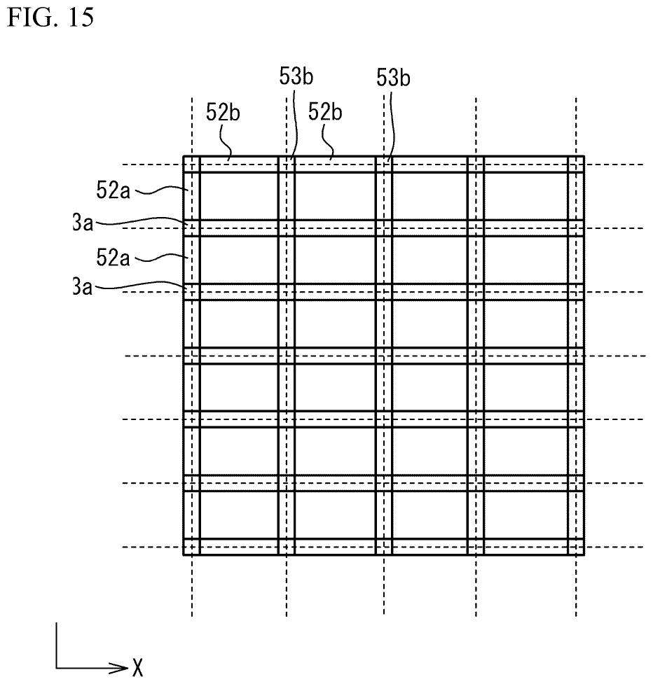

Next, as illustrated in FIG. 15, a green chip before firing of the multilayer chip 60 is obtained by cutting along cut lines along the X-axis direction and the Y-axis direction from the Z-axis direction.

(Firing process) Next, the multilayer chip 60 is obtained by firing the obtained green chip. The firing conditions are not particularly limited, and may be set to a maximum temperature of preferably 400° C. to 1000° C., more preferably 500° C. to 900° C., in an oxidizing or non-oxidizing atmosphere. A process of maintaining the temperature in an oxidizing atmosphere at a temperature lower than the maximum temperature may be provided in order to sufficiently remove the binder before the maximum temperature is reached. In order to reduce process costs, it is desirable to perform firing at as low a temperature as possible. After firing, a re-oxidation process may be performed.

(External electrode formation process) Next, the first external electrodes 41a and 41b and the second external electrode 42 are formed by applying and forming and curing a paste for external electrodes on two end faces of the multilayer chip 60, thereby obtaining the all solid battery 100a.

(Mounting and sealing process) Next, the all solid battery 100a is mounted on the mounting board 200, and the all solid battery 100a is sealed with the exterior member 301 to obtain the package component 300.

### Example

(Example) Stacked type all solid batteries were produced according to the above embodiment. As illustrated in FIG. 14, the first solid electrolyte green sheet 51a on which the positive electrode pattern 52a and the positive electrode margin portion paste 53a were printed, and the second solid electrolyte green sheet 51b on which the negative electrode pattern 52b and the negative electrode margin portion paste 53b were printed were alternately stacked, and cover sheets were provided above and below in the stacking direction. After pressure molding, individual chips were obtained by cutting along the cut lines illustrated in FIG. 15, and 24 numbers of the multilayer chips 60 were obtained by degreasing and firing. No cracks or the like were observed in any of the chips after firing.

The all solid batteries 100a were produced by forming the first external electrodes 41a and 41b and the second external electrode 42 as illustrated in FIG. 7, and a charge-discharge test was performed. No failures occurred in any of the chips during the first charge.

The battery was mounted on the mounting board 200 illustrated in FIG. 8 by soldering. Three joints were used for soldering. The battery could be mounted without shorting. The adhesive strength was 200 N. After that, as illustrated in FIG. 10, the all solid battery 100a was sealed with the exterior member 301 to obtain the package component 300. By sealing, even when the positive electrode and the negative electrode were exposed from the side and end faces of the multilayer chip, the charge and discharge cycles could be repeated stably in the air.

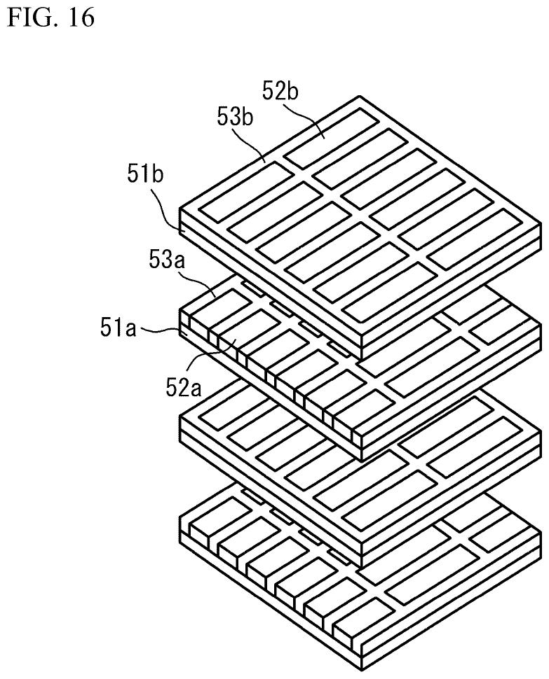

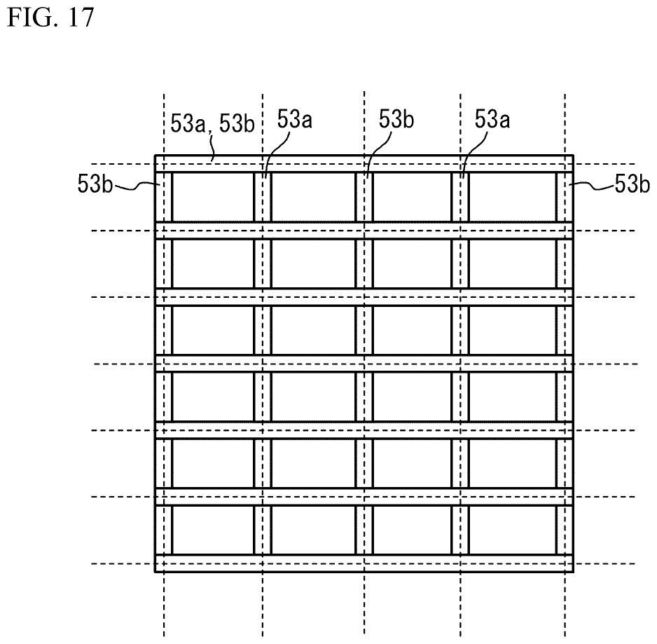

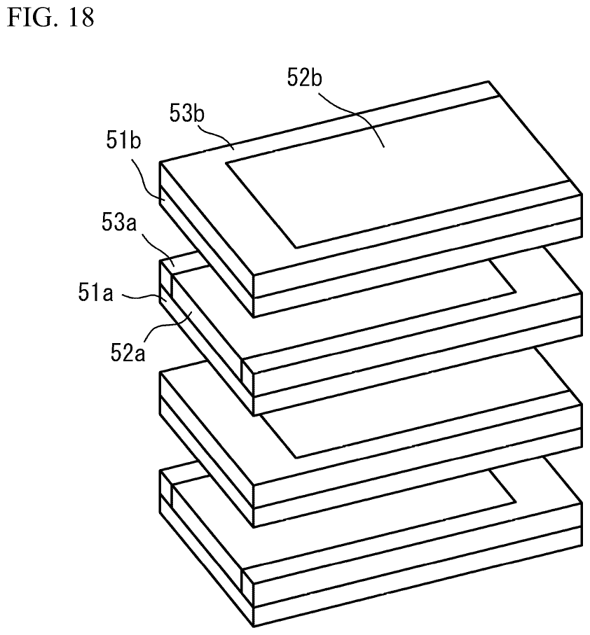

(Comparative Example) As illustrated in FIG. 16, the first solid electrolyte green sheet 51a on which the positive electrode pattern 52a and the positive electrode margin portion paste 53a were printed and the second solid electrolyte green sheet 51b on which the negative electrode pattern 52b and the negative electrode margin portion paste 53b were printed were alternately stacked, and cover sheets were provided above and below the stacking direction. After pressure molding, individual chips were obtained by cutting along the cut lines as illustrated in FIG. 17, and 24 number of the multilayer chips were obtained by degreasing and firing. As illustrated in FIG. 18, the positive electrode margin portion paste 53a and the negative electrode margin portion paste 53b were formed into a lateral C shape. The size of the obtained multilayer chip was the same as that of the multilayer chip 60 of the embodiment. Visually recognizable cracks were observed in three of the 24 chips.

It was difficult to visually distinguish the polarity of the multilayer chips obtained in Comparative Example. The polarity could be distinguished by observation under a microscope, so they were mounted on a mounting board, paying attention to the orientation of the positive and negative electrodes. External electrodes were formed on the 21 chips that had no cracks to obtain all solid batteries, and a charge/discharge test was performed. Soft short failures were confirmed on the first charge in five chips. It was speculated that the malfunction during charging was caused by internal microcracks growing due to volume changes in the electrodes during the charging process, causing a misalignment of the multilayer structure.

Although the embodiments of the present invention have been described in detail, it is to be understood that the various change, substitutions, and alterations could be made hereto without departing from the spirit and scope of the invention.

What is claimed is:

1. An all solid battery comprising:
a multilayer body having a substantially rectangular parallelepiped shape, in which a first electrode layer including a first electrode and a first margin portion and a second electrode layer including a second electrode different from the first electrode and a second margin portion are stacked in multiple layers with a solid electrolyte layer sandwiched therebetween,
wherein among four side faces other than an upper face and a lower face at ends of the multilayer body in a stacking direction, the first margin portion is arranged so as to be exposed to first two side faces facing each other, the first electrode is extended to second two side faces other than the first two side faces, the second margin portion is arranged so as to be exposed to the second two side faces, and the second electrode is extended to the first two side faces.

2. The all solid battery as claimed in claim 1 further comprising:
two first external electrodes connected to the first two side faces respectively; and
a second external electrode connected to the second two side faces.

3. The all solid battery as claimed in claim 1, wherein a first length of the multilayer body in a direction in which the first two side faces face each other is different from a second length of the multilayer body in a direction in which the second two side faces face each other.

4. The all solid battery as claimed in claim 3, wherein the first length is 1.1 times or more the second length.

5. The all solid battery as claimed in claim 1, wherein the first margin portion and the second margin portion are substantially rectangular in a plan view along the stacking direction.

6. The all solid battery as claimed in claim 5, wherein the first electrode and the second electrode are substantially rectangular in the plan view along the stacking direction.

7. A package component comprising:
a board;
an all solid battery as claimed in claim 1 which is mounted on the board; and
an exterior member that isolates the all solid battery from outside air.

8. A manufacturing method of an all solid battery comprising:
firing a multilayer body having a substantially rectangular parallelepiped shape, in which a first electrode layer including a first electrode pattern and a first margin portion paste and a second electrode layer including a second electrode pattern different from the first electrode pattern and a second margin portion paste are stacked in multiple layers with a solid electrolyte layer green sheet sandwiched therebetween,
wherein among four side faces other than an upper face and a lower face at ends of the multilayer body in a stacking direction, the first margin portion paste is arranged so as to be exposed to first two side faces facing each other, the first electrode pattern is extended to second two side faces other than the first two side faces, the second margin portion paste is arranged so as to be exposed to the second two side faces, and the second electrode pattern is extended to the first two side faces.

9. The manufacturing method as claimed in claim 8, wherein the multilayer body is fired after polishing a surface of the multilayer body.
